(19) United States
(12) Patent Application Publication
(10) Pub. No.: US 2010/0214494 A1
(43) Pub. Date: Aug. 26, 2010

(54) TUNER

(76) Inventors: Katsumasa YOKOUCHI, Yokohama (JP); Hiroshi Takahashi, Yokohama (JP); Seiichi Sato, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/609,298

(22) Filed: Oct. 30, 2009

(30) Foreign Application Priority Data
Feb. 26, 2009 (JP) 2009-044212

(51) Int. Cl. H04N 5/50

(52) U.S. Cl. 348/731; 348/E05.097

(57) ABSTRACT

A small tuner for a receiver, for example, a TV receiver is provided which requires a reduced area for mounting on a main signal board. A tuner board is disposed perpendicularly to a connector, for example, an F connector so as to allow an output signal of the tuner board to be outputted downwardly and thereby reduce the area required to mount the tuner. With the tuner made smaller and more immune to noise, a portion facing the tuner board of the shield case for the tuner is removed and a ground pattern is formed over the tuner board surface facing the removed portion of the tuner case. The core line of the F connector is bent to be connected to an end portion of the tuner board so as to facilitate laying out the tuner board.

### INFORMATION BY REFERENCE

The present application claims priority from Japanese application JP2009-044212 filed on Feb. 26, 2009, the entire content of which is hereby incorporated by reference into this application.

### BACKGROUND OF THE INVENTION

The present invention relates to a tuner for a receiver, for example, a TV receiver and, more particularly, to a small tuner requiring a reduced area for mounting on a circuit board of a receiver.

There have been tuners for receivers, for example, TV receivers modularized using structures such as those disclosed in Unexamined Patent Application Publication Nos. H10 (1998)-215148 and 2003-304162. As shown in FIG. 1 of each of the above patent documents, a tuner board on which circuit components including an amplifier circuit, a mixer circuit, a local oscillator, and a filter are mounted is mounted along the direction of a connector (antenna terminal), to which a cable for supplying a radio frequency signal from an antenna is connected, i.e. along the direction in which the cable is inserted into the connector. The connector has a diameter of about 10 mm. Generally, the depth of the tuner board and at least one of the other two sides of the tuner board each measures three times the connector diameter or more.

### SUMMARY OF THE INVENTION

Recently, in the field of receiving apparatuses including mobile-phones and TV receivers, there is growing demand for component miniaturization. The component miniaturization being demanded is required not only to make receivers smaller but also to allow components, for example, tuners for processing radio-frequency signals to function easily in a mounted state. It is therefore necessary to further promote development of a smaller tuner without staying with existing techniques as those disclosed by the patent documents referred to above.

An object of the present invention that has been made in view of the above situation is to provide a small tuner requiring a reduced area for mounting on a circuit board of a receiver.

To achieve the above object, the present invention provides a tuner for outputting a received signal after subjecting it to power-amplification and frequency conversion. The tuner comprises: a connector which is connected with a cable for transmitting the received signal and which has a core line for outputting the received signal; a tuner board on which a tuner circuit to perform signal processing including the power-amplification and frequency conversion is mounted, the tuner board being disposed perpendicularly to a direction in which the cable is inserted into the connector; and a shield case which enhances immunity to noise caused by radio waves coming from outside the tuner board.

According to the present invention, a small tuner requiring a reduced area for mounting on a circuit board of a receiver can be provided, so that the invention can contribute toward further miniaturization of receivers, for example, TV receivers.

### BRIEF DESCRIPTION OF THE DRAWINGS

These and other features, objects and advantages of the present invention will become more apparent from the following description when taken in conjunction with the accompanying drawing wherein:

FIG. 1 is a block diagram of an example broadcast receiver to which the present invention is applied.

FIG. 2A is a see-through side view of a tuner according to a first embodiment of the invention.

FIG. 2B is a front view of a tuner board included in the tuner according to the first embodiment of the invention.

FIG. 2C is a see-through side view showing how the tuner according to the first embodiment of the invention is installed.

FIG. 2D is a see-through front view of the tuner according to the first embodiment of the invention.

FIG. 3A is a see-through side view of a tuner according to a second embodiment of the invention.

FIG. 3B is a front view of a tuner board included in the tuner according to the second embodiment of the invention.

FIG. 3C is a see-through side view showing how the tuner according to the second embodiment of the invention is installed.

FIG. 4A is a see-through side view of a tuner according to a third embodiment of the invention.

FIG. 4B is a front view of a tuner board included in the tuner according to the third embodiment of the invention.

FIG. 4C is a see-through side view showing how the tuner according to the third embodiment of the invention is installed.

FIG. 4D is a front view of a main signal board according to the third embodiment of the invention.

FIG. 5 is a see-through side view of a tuner according to a fourth embodiment of the invention.

FIG. 6A is a see-through side view of a tuner according to a fifth embodiment of the invention.

FIG. 6B is a front view of a tuner board included in the tuner according to the fifth embodiment of the invention.

FIG. 6C is a see-through side view showing how the tuner according to the fifth embodiment of the invention is installed.

FIG. 7A is a side view, as seen from a direction, of an F connector.

FIG. 7B is a side view, as seen from another direction, of the F connector.

FIG. 8A is a side view of an F connector according to the fifth embodiment of the invention.

FIG. 8B is a side view of another F connector according to the fifth embodiment of the invention.

FIG. 9A is a see-through side view of a tuner according to a sixth embodiment of the invention.

FIG. 9B is a front view of a tuner board included in the tuner according to the sixth embodiment of the invention.

FIG. 9C is a see-through side view showing how the tuner according to the sixth embodiment of the invention is installed.

FIG. 9D is a see-through front view of the tuner according to the sixth embodiment of the invention.

### DETAILED DESCRIPTION OF THE EMBODIMENTS

Embodiments of the present invention will be described below with reference to the attached drawings.

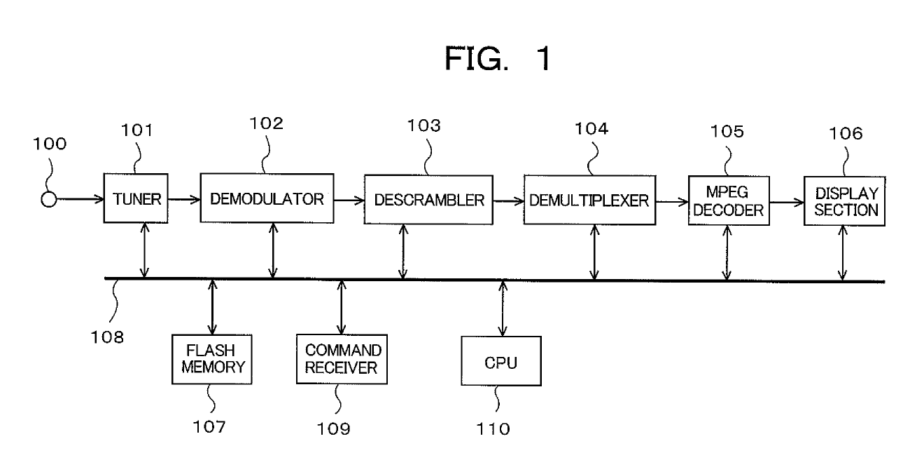

FIG. 1 is a block diagram of an example broadcast receiver to which the invention is applied. The overall operation of the broadcast receiver will be described based on FIG. 1.

An input terminal 100 receives broadcast radio waves supplied from an antenna (not shown), and a broadcast channel desired by a user is selected at a tuner 101. The user may select a satellite or terrestrial broadcast channel, or even a cable TV channel. The channel to be selected at the tuner 101 is determined, for example, by a command which is transmitted from the user using a remote controller (not shown) to a command receiver 109 causing a CPU 110 to control the tuner 101 via a bus 108. The broadcast signal of the selected channel is, at a demodulator 102, demodulated depending on the modulation method applied to the broadcast signal and errors generated in the signal during the transmission are corrected. In cases where the broadcast signal has been scrambled for higher confidentiality by the broadcaster, it is descrambled at a descrambler 103.

In the case of digital broadcasting, plural, for example, three programs are time-division multiplexed per channel, so that the video content of a slot desired by the user is selected at a demultiplexer 104 according to a command issued by the user, for example, using a remote controller in a manner similar to that described above with regard to the tuner 101. The selected video content is, at an MPEG (Moving Picture Experts Group) decoder 105, released from the MPEG compression applied to it at the corresponding broadcast station to be expanded into three primary-color signals for display, then fed to a display section 106 to allow the user to watch the program displayed on the display section 106.

Even though, not to complicate the drawing, FIG. 1 shows no audio components such as an audio signal processing circuit and a speaker, audio information to accompany the video content is also processed appropriately and outputted to a speaker. To display an electronic program guide (EPG), the program information sequentially received as made available while broadcasting goes on is accumulated, for example, in a flash memory 107. Subsequently, the program information on all channels is outputted in time-series mode to the display section 106 in a prescribed listing format. This allows the user to program his or her viewing or recording of a program of his or her choice.

Of the above components of the broadcast receiver, the tuner 101 processes the radio-frequency signals received via the input terminal 100. The tuner 101 includes such circuit components as an amplifier circuit, a mixer circuit, a local oscillator, and a filter. When a radio-frequency signal is received, the tuner 101 outputs the signal after subjecting it to power-amplification and frequency-conversion into a frequency band appropriate for processing by the demodulator 102. In the frequency conversion process, traditionally the frequency of the received signal is lowered into an intermediate frequency band before the signal is sent to the demodulator 102. Recently, however, a direct conversion method is adopted in many cases, that is, the signal frequency is converted directly into a base band frequency.

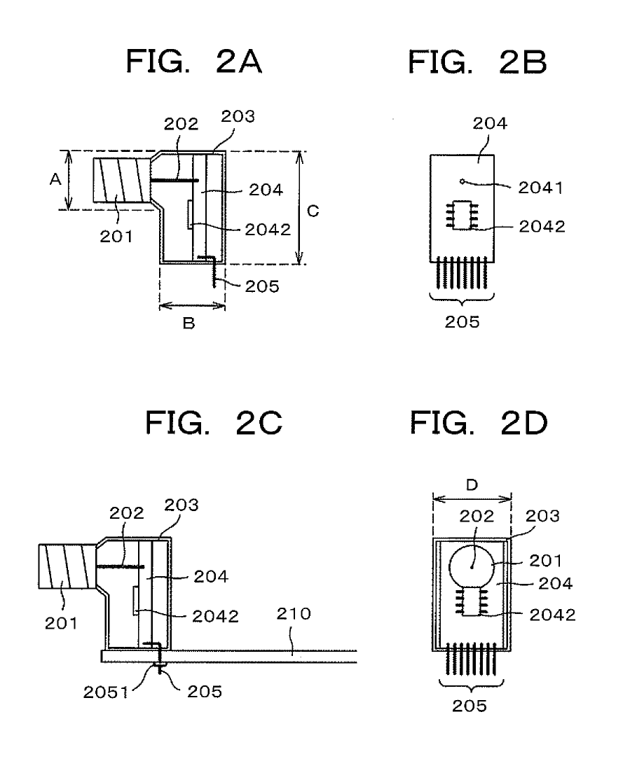

In connection with the tuner 101 shown in FIG. 1, an embodiment of the present invention will be described with reference to the subsequent drawings. FIG. 2A is a see-through side view of a tuner according to a first embodiment of the present invention.

In FIG. 2A, reference numeral 201 denotes an F connector widely used to input or output a signal of a UHF or higher frequency. A cable (not shown) leading from the antenna is connected to the F connector 201, shown as seen from a side, from the left side as seen in FIG. 2A. As shown in FIG. 2A, the F connector 201 is, in many cases, provided with a threaded part for fixing a connector attached to the cable. Reference numeral 202 denotes a core line of the F connector 201. It is connected to a tuner board 204 to input the signal from the antenna to the tuner board.

In FIG. 2A, the tuner board 204 is shown to show a side edge portion thereof. The tuner board 204 is provided, for example, with a signal processing circuit component on its surface on the F connector side. In the present example, a tuner integrated circuit 2042 is mounted on the surface. The received signal is subjected to power amplification, frequency conversion, and local signal oscillation in the tuner integrated circuit 2042. Not all the tuner circuit components need to be mounted on the same side of the tuner board 204. Some of them may be mounted on the other side of the tuner board 204. The signal, after its frequency is converted into a frequency band appropriate to undergo demodulation at the demodulator 102 shown in FIG. 1, is outputted from terminals 205.

Reference numeral 203 denotes a shield case which shields the tuner from external radio interference while also preventing the tuner from emitting unwanted radio waves to outside. In FIG. 2A, the shield case 203 is shown without a side portion thereof so that the interior of the tuner is visible. The shield case 203 shown in FIG. 2A has a tapered portion toward the F connector 201, but the tapered portion is not a requirement. For example, the connection between the shield case 203 and the F connector 201 may be fixed by a clamping nut provided for the F connector 201.

FIG. 2B shows the tuner board 204 and the terminals 205 as seen from the left side in FIG. 2A, that is, as seen from the component-mounted side of the tuner board 204. The core line 202 is connected to a pattern 2041. The signal inputted through the core line 202 is processed, as described above, in the tuner integrated circuit 2042, then outputted from the terminals 205. The terminals 205 shown in FIG. 2B are pin-like terminals totaling eight, but they may total more than or fewer than eight. The terminals are used to output/input, for example, the output signal, a power supply, a ground potential, and a control signal.

FIG. 2C shows the tuner shown in FIG. 2A in a state in which it is mounted on a main signal board 210 of a receiver, for example, a TV receiver. The terminals 205 are connected, for example, by soldering, to patterns 2051 formed on the main signal board 210 so as to input/output, for example, power supplies and signals. Though not shown, the demodulator 102 and the circuit components downstream of the demodulator 102 shown in FIG. 1 are mounted on the main signal board 210.

FIG. 2D shows the tuner shown in FIG. 2A as seen from the left side in FIG. 2A. In FIG. 2D, the tuner is shown without a front portion of the shield case 203 so that the interior of the tuner is visible.

In the present embodiment, unlike in the tuner configuration disclosed in Japanese Unexamined Patent Application Publication No. H10 (1998)-215148 or No. 2003-304162, the tuner board 204 is positioned perpendicularly to the direction (the left-to-right direction as seen in FIG. 2A) in which a cable is inserted into the F connector 201, and the terminals 205 extend downwardly from the tuner board 204 toward the main signal board 210. Hence, in this configuration, compared with prior-art configurations like the one mentioned above, the length denoted by “B” in FIG. 2A can be largely shortened to reduce the tuner area requirement on the main signal board 210.

In the present embodiment, not only the length B shown in FIG. 2A is reduced but also the height denoted by “C” in FIG. 2A and the width denoted by “D” in FIG. 2D are each smaller than twice the diameter A, including the connecting part shown in FIG. 2A, of the F connector 201. In this tuner configuration, unlike in prior-art tuner configurations, the F connector is not attached to the tuner module, but the F connector incorporates the tuner module. Thus, the F connector incorporating the tuner module can be mounted on the main signal board 210 without being concerned about the size of the tuner board 204 fixed perpendicularly to the F connector, and the tuner area requirement on the main signal board 210 is reduced.

What has made it possible to mount the whole tuner circuit on the small tuner board 204 includes the adoption of the one-chip IC (the tuner integrated circuit 2042 shown in FIG. 2B) and the application of the direct conversion method for signal frequency conversion resulting in a reduced number of large filters (not shown). In the future, the tuner might be made small enough to be accommodated in the size of the F connector by devising additional measures, for example, mounting an IC and SAW (surface acoustic wave) filters prepared as bare chips. In such a case, too, the configuration in which the tuner board 204 is provided perpendicularly to the direction of cable insertion into the F connector is effective in reducing the area required to mount the tuner on the main signal board.

There is another advantageous effect of making the tuner smaller. Generally, when the tuner is smaller, immunity to noise caused by radio waves coming from outside the tuner board is larger, so that the tuner can function easily in a mounted state. This will be further described later.

Referring to FIGS. 2A, 2C, and 2D, even though the tuner board 204 is, at its top and bottom portions, in contact with the shield case 203 allowing its ground to be connected to the shield case 203, this is not a requirement. The tuner board 204 may not be in contact with the shield case 203.

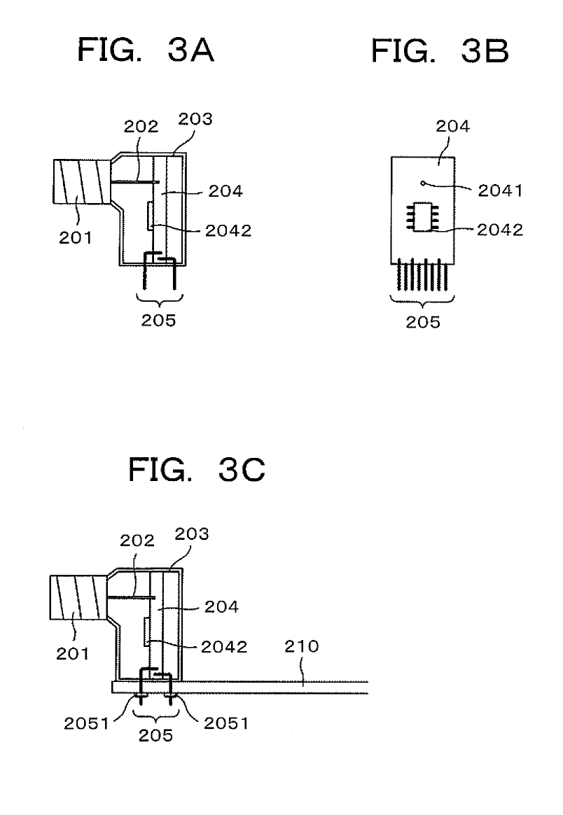

Another embodiment which is different from the above embodiment described with reference to FIGS. 2A to 2D will be described below. FIG. 3A is a see-through side view of a tuner according to a second embodiment of the present invention.

The terminals 205 shown in FIG. 3A include, unlike those shown in FIG. 2A, eight terminals with four each extending from each side of the tuner board 204. Recently, the tuner board 204 has, in many cases, a multilayer structure. In such cases, the terminals 205 extending from both sides of the tuner board 204 provide more flexibility in mounting the tuner on the main signal board 210, while also allowing the tuner to be mounted with greater strength. In other respects, the second embodiment is similar to the first embodiment, so that the second embodiment will not be described further.

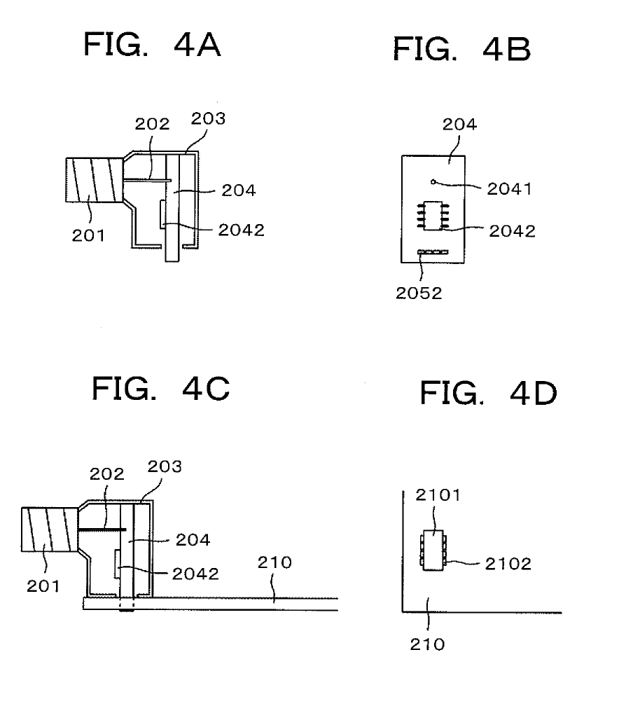

Another embodiment which is different from the above embodiment described with reference to FIGS. 3A to 3C will be described below. FIG. 4A is a see-through side view of a tuner according to a third embodiment of the present invention.

The tuner board 204 shown in FIG. 4A, unlike the one shown in FIG. 3A, partly projects out of the shield case 203 while it has no pin-like terminal 205. In the third embodiment, the tuner board 204 has, as shown in FIG. 4B, four patterns 2052 on each side (only one of the two sides is shown in FIG. 4B), whereas the main signal board 210 has, as shown in FIG. 4D, eight patterns 2102 on both sides of a through hole 2101. The tuner board 204 is mounted, as shown in FIG. 4C, such that a portion thereof is inserted through the through hole 2101 to allow the patterns 2052 provided on the tuner board 204 and the patterns 2102 provided on the main signal board 210 to be mutually connected, for example, by soldering. In this case, too, the tuner board 204 may have the pin-like terminals 205 as shown in FIG. 3C for connection to the main signal board 210 and the pin-like terminals may be provided only on one side of the tuner board 204 as shown in FIG. 2C.

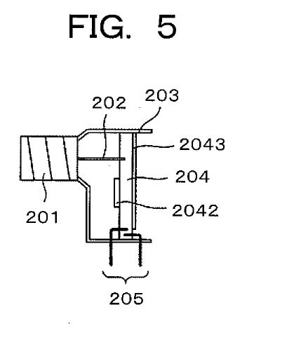

Still another embodiment which is different from the above embodiment described with reference to FIGS. 3A to 3C will be described below. FIG. 5 is a see-through side view of a tuner according to a fourth embodiment of the present invention.

As stated above, in the embodiments of the present invention, making the tuner smaller makes the tuner more immune to externally generated noise. This may make it possible to remove part of the shield case 203. In the fourth embodiment shown in FIG. 5, a portion on the opposite side to the F connector 201 (on the right side as seen in FIG. 5) of the shield case is removed, and the surface on the same side (on the right side as seen in FIG. 5) of the tuner board 204 is covered, as fully as possible, with a ground pattern 2043 so as to generate an effect of shielding externally generated noise. Generally, the shielding effect of the ground pattern 2043 is, in many cases, smaller than that of the shield case 203. In the present embodiment, however, the small tuner is highly noise immune, so that, depending on the case, the shielding effect of the ground pattern 2043 may be strong enough.

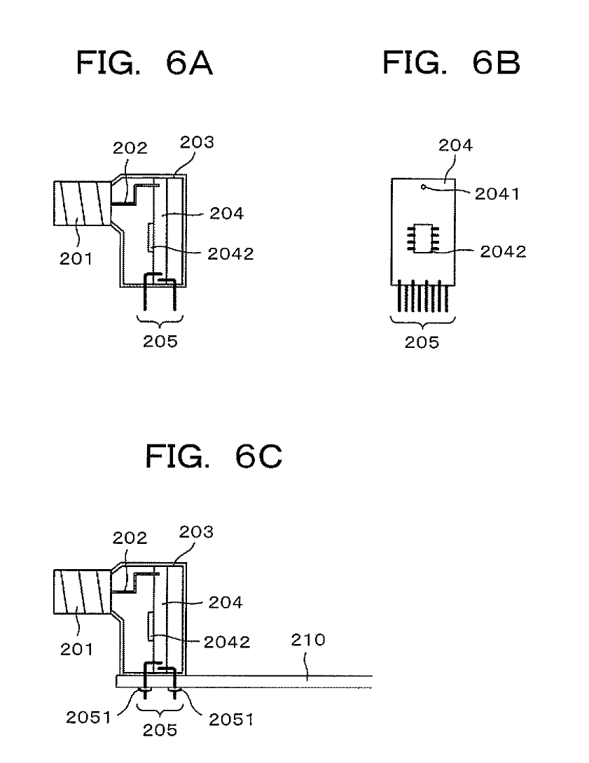

Still another embodiment of the present invention will be described next. FIG. 6A is a see-through side view of a tuner according to a fifth embodiment of the present invention.

In the foregoing embodiments, the pattern 2041 on the tuner board 204 is positioned correspondingly to the center of the F connector 201. Generally, however, when the tuner board has its signal input part located at an end portion opposite to the signal output terminals 205, it is easier to lay out components on the tuner board to eventually facilitate making the tuner board smaller. On the tuner board 204 shown in FIG. 6B, the pattern 2041 is located in an upper end portion, whereas the core line 202 of the F connector 201 is bent, as shown in FIG. 6A, to be connected to the pattern 2041. In other respects, the fifth embodiment is similar to the second embodiment shown in FIGS. 3A to 3C.

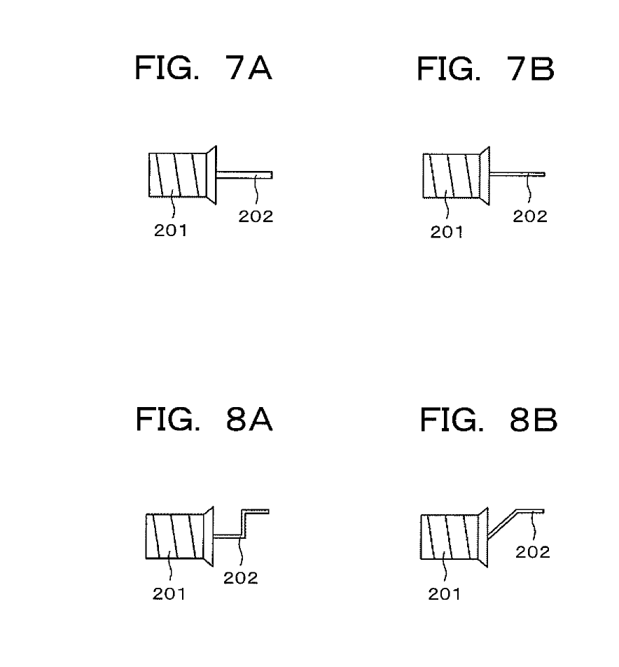

The F connector 201 and the core line 202 will be described below with reference to FIGS. 7A, 7B, 8A, and 8B. The core line 202 is, in many cases, made of a rectangular wire. FIG. 7A is a side view showing a thicker side of the core wire 202. When the core wire 202 in the state shown in FIG. 7A is turned 90° about its axis, it shows a thinner side thereof as shown in FIG. 7B. To realize an embodiment like the one shown in FIG. 6A to 6C, the core wire 202 in the state shown in FIG. 7B is bent into a state shown in FIG. 8A or 8B. In the case of the embodiment shown in FIGS. 6A to 6C, the core wire 202 is bent as shown in FIG. 8A.

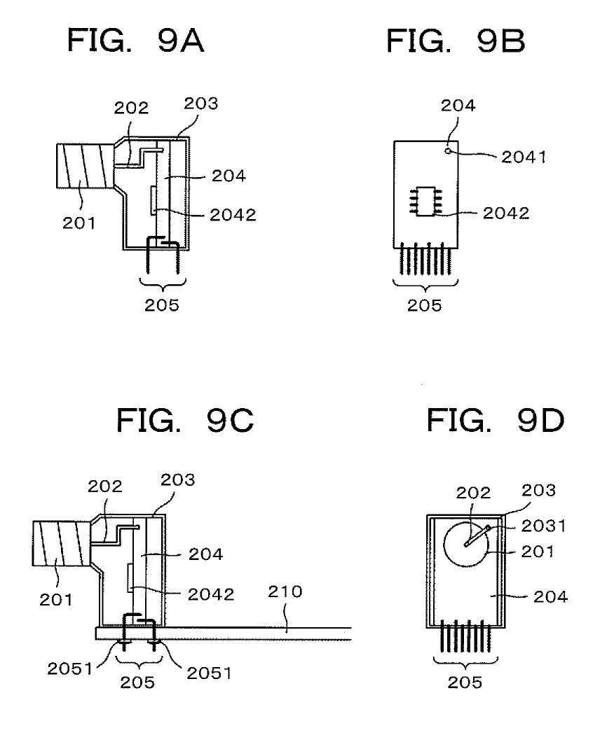

Still another embodiment, which is different from the one shown in FIGS. 6A to 6C, of the present invention will be described below. FIG. 9A is a see-through side view of a tuner according to a sixth embodiment of the present invention.

The embodiment shown in FIGS. 9A to 9D is appropriate in cases where a received signal can be conveniently inputted to the tuner integrated circuit 2042 with the pattern 2041 located toward a side, for example, toward the right edge in an upper portion of the tuner board 204. For the embodiment, the F connector 201 from which the core wire 202 bent as shown in FIG. 8A extends is turned 45° clockwise to allow the core wire to be connected to the pattern 2041. Hence, the core wire 202 look thicker in FIGS. 9A and 9C than in the corresponding drawings for the foregoing embodiments.

Even though the terminals 205 shown in FIG. 5A, 6A, or 9A look similar to those shown in FIG. 3A, they may be differently arranged, for example, as shown in FIG. 2A or 4A.

The above embodiments have been described based on the assumption that the demodulator 102 shown in FIG. 1 is provided not on the tuner board 204 but on the main signal board 210. In the future, an arrangement might be made such that the demodulator 102 is mounted on the tuner board 204 and such that a TS (transport stream) signal after demodulation is outputted to the terminals 205 or the patterns 2052. Such an arrangement also falls in the scope of the present invention. Namely, the TS signal can be an output signal generated by subjecting an input signal to power-amplification and frequency conversion according to the embodiments of the present invention.

The above embodiments have been described only as examples, and the present invention is not limited to the embodiments. For example, the connector to be used need not be an F connector, and the tuner need not be one for TV reception. Many other modifications can be made to the above embodiments without departing from the scope of the invention.

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A tuner which outputs a received signal after subjecting it to power-amplification and frequency conversion, comprising:
a connector which is connected with a cable for transmitting the received signal and which has a core line for outputting the received signal;
a tuner board on which a tuner circuit to perform signal processing including the power-amplification and frequency conversion is mounted, the tuner board being disposed perpendicularly to a direction in which the cable is inserted into the connector; and
a shield case which enhances immunity to noise caused by radio waves coming from outside the tuner board.

2. The tuner according to claim 1, wherein the tuner board has a terminal which outputs the received signal, after the received signal is power-amplified and frequency-converted, in a direction perpendicular to the direction of cable insertion into the connector.

3. The tuner according to claim 1, wherein the tuner board is mounted perpendicularly to a main signal board which processes the received signal after the received signal is power-amplified and frequency-converted.

4. The tuner according to claim 1, wherein the tuner board has a multilayer structure; the shield case is structured to shield only one side of the tuner board; and shielding against external radio waves coming toward the other side of the tuner board is provided by a ground pattern formed on the other side of the tuner board.

5. The tuner according to claim 1, wherein the core line of the connector is bent to be connected to a part of the tuner board, the part being shifted from directly in front of the connector toward an end portion of the tuner board.
